(19) United States
(12) Patent Application Publication
(10) Pub. No.: US 2010/0238290 A1
(43) Pub. Date: Sep. 23, 2010

(54) DRIVE OVER VEHICLE INSPECTION SYSTEMS AND METHODS

(75) Inventors: Larry E. Riley, Fritz Creek, AK (US); W. Garth Bradshaw, Homer, AK (US)

Correspondence Address: SNELL & WILMER L.L.P. (Main), 400 EAST VAN BUREN, ONE ARIZONA CENTER, PHOENIX, AZ, 85004-2202, US

(73) Assignee: KACHEMAK RESEARCH DEVELOPMENT, INC., Homer, AK (US)

(21) Appl. No.: 12/549,036

(22) Filed: Aug. 27, 2009

Related U.S. Application Data
(60) Provisional application No. 61/092,173, filed on Aug. 27, 2008.

(51) Int. Cl. H04N 7/18

(52) U.S. Cl. 348/148; 348/E07.085

(57) ABSTRACT

In accordance with exemplary embodiments, the present invention is a drive over vehicle inspection system comprising a camera and a speed sensor configured to detect variations in the spatial relationship with the vehicle's undercarriage as the vehicle is driven over the device. In exemplary embodiments, the speed sensor is in communication with a controller configured to adjust the camera's settings to thereby compensate for variations in the vehicle's speed. In exemplary embodiments, the present invention is permanently located in the ground, while in other exemplary embodiments, the present invention is a portable device located above the ground, similar to a ramp or speed bump.

### CROSS-REFERENCE TO RELATED APPLICATIONS

This application claims priority to and the benefit of U.S. Provisional Patent Application Ser. No. 61/092,173, entitled “Drive Over Inspection System,” filed Aug. 27, 2008, which is incorporated by reference herein in its entirety.

### STATEMENT OF GOVERNMENT SPONSORED RESEARCH

One or more agencies of the United States Government have a paid-up license in this invention and may in limited circumstances possess the right to require the patent owner to license others on reasonable terms as provided by the terms of Government Contract Number FA4819-06-C-0012 awarded by the Air Force Research Laboratory, Tyndall AFB, Florida.

### BACKGROUND OF THE INVENTION

Criminals and terrorists have been known to transport drugs, explosives, stolen goods, and other forms of contraband in the undercarriages of vehicles. The term “undercarriage” as used herein refers to all or part of the undercarriage of a vehicle, such as wheel wells and areas between engine parts. The term “vehicle” as used herein refers at least to automobiles, vans, small trucks, construction equipment, large trucks, such as so-called 18-wheelers, ATVs, and trains, as well as associated trailers and other towed assemblies.

Inspection stations have traditionally been set up in a variety of locations to prevent the passage of contraband hidden in the undercarriages of vehicles. For example, international and state border crossings, airports, military and security checkpoints, and even many commercial structures, such as concerts and sporting events, are protected by systems designed to inspect the undercarriages of vehicles.

Perhaps the most common method used to inspect the undercarriages of vehicles involves a human inspector manipulating a mirror attached to the end of a stick. The inspector manually positions the mirror underneath a vehicle in such a way that he or she can view portions of the vehicle's undercarriage in the mirror's reflection. This allows the inspector to examine the vehicle's undercarriage without having to kneel down or crawl underneath the vehicle.

The so called “mirror on a stick” approach has a number of fairly obvious shortcomings. Most notably, this approach puts the inspector in physical danger by placing him or her near potentially harmful substances, e.g. explosives, caustic chemicals, biological weapons, etc. Furthermore, scanning the entire undercarriage of a vehicle using a mirror on a stick takes a considerable amount of time, which typically leads to serious congestion in high-traffic areas. Moreover, human inspectors often fail to notice important details when they are fatigued or in a rush, thereby limiting the reliability of their inspections.

A number of more sophisticated approaches have been proposed in an attempt to provide safer, more efficient, and more reliable ways of inspecting vehicle undercarriages. One exemplary approach uses drive over vehicle inspection systems (“DOVISes”).

Conventional DOVISes are characterized by the use of fixed (e.g., unmoving) cameras that image some portion of a vehicle's undercarriage as the vehicle is driven over the device. Some of these devices use multiple still area scan cameras, multiple video cameras, a combination of still area scan and video cameras, or some may even use line scan cameras. A conventional DOVIS captures a number of images of the vehicle's undercarriage and then sends the images to a human inspector for analysis.

Conventional DOVISes have several drawbacks. For example, conventional DOVISes generally produce very poor quality (e.g., compressed or blurry) images due to the fact that the vehicles driven over these devices often travel at inconsistent speeds.

Furthermore, cameras fixed in conventional DOVISes are generally incapable of selectively focusing in on suspicious areas of the vehicle's undercarriage or adjusting their imaging view around a difficult angle. As such, conventional DOVISes are unable to inspect areas such as wheel wells, which are a common place for stowing contraband.

In addition, conventional DOVISes have a tendency to be affected by environmental conditions such as debris and changing weather. The problem may occur, for example, when substances such as dirt or mud come into contact with these devices' optical, mechanical, or electrical components, or when the air temperature causes temperature sensitive electronic components including digital image sensors to perform sub-optimally.

The tendency to be adversely affected by environmental conditions increases the maintenance cost and decreases the reliability of conventional DOVISes, and the inability to detect variations in the spatial relationship with the vehicle's undercarriage tends to complicate the image capture and analysis process.

Due to these and other limitations in the alternate approaches, the “mirror on a stick” approach remains one of the most reliable forms of undercarriage inspection. Given limited reliability of this approach and the great risk that it presents to inspection personnel, however, the “mirror on a stick” approach is unacceptable.

What is needed, therefore, is a device which is at least as reliable as the “mirror on a stick” approach, yet which provides a safe and efficient way of inspecting the undercarriages of vehicles.

### SUMMARY OF THE INVENTION

In accordance with exemplary embodiments, the present invention is a drive over vehicle inspection system comprising a camera and a speed sensor. In accordance with one exemplary embodiment, the DOVIS is configured to detect variations in the vehicles speed as the vehicle is driven over the device. In accordance with another exemplary embodiment, the DOVIS is configured to detect variations in the spatial relationship with the vehicle's undercarriage as the vehicle is driven over the device. In exemplary embodiments, the speed sensor is in communication with a controller. The controller, in various exemplary embodiments is configured to adjust the camera's settings to thereby compensate for variations in the vehicle's speed.

In accordance with exemplary methods of use, as the vehicle is driven over the camera, the controller sends signals, based on information from the speed sensor, to the camera to adjust the camera setting(s). In exemplary embodiments, the controller performs this routine either continuously or at predetermined intervals. The result is that vehicle speed is not reflected in the image.

In exemplary embodiments, the present invention is permanently located in the ground, while in other exemplary embodiments, the present invention is a portable device located above the ground, similar to a ramp or speed bump.

### BRIEF DESCRIPTION OF THE DRAWINGS

The exemplary embodiments of the present invention will be described in conjunction with the appended drawing figures in which like numerals denote like elements and:

FIG. 1 illustrates a block diagram of a drive over vehicle inspection system in accordance with an exemplary embodiment of the present invention;

FIG. 2 illustrates an in-ground drive over vehicle inspection system housing in accordance with an exemplary embodiment of the present invention;

FIG. 3 illustrates a portable drive over vehicle inspection system housing in accordance with an exemplary embodiment of the present invention;

FIG. 4 illustrates a housing that is moldable in accordance with an exemplary embodiment of the present invention;

FIG. 5 illustrates a camera box for a drive over vehicle inspection system in accordance with an exemplary embodiment of the present invention;

FIG. 6 illustrates the camera box of FIG. 5 in its assembled form in an exemplary embodiment of the present invention;

FIG. 7 illustrates a rotationally molded camera box for a drive over vehicle inspection system in accordance with an exemplary embodiment of the present invention;

FIG. 8 illustrates a cooling system for a drive over vehicle inspection system in accordance with an exemplary embodiment of the present invention;

FIG. 9 illustrates an exemplary light box in accordance with an exemplary embodiment of the present invention;

FIG. 10 illustrates an exemplary light box relative to an exemplary camera box in accordance with an exemplary embodiment of the present invention;

FIG. 11 illustrates an exemplary camera box window cleaning system in accordance with an exemplary embodiment of the present invention;

FIG. 12 illustrates a side view of the camera box window cleaning system of FIG. 11 in accordance with an exemplary embodiment of the present invention;

FIGS. 13A and 13B illustrate an exemplary wheel well imaging system in accordance with an exemplary embodiment of the present invention; and

FIG. 14 illustrates a block diagram of a method in accordance with an exemplary embodiment of the present invention.

### DETAILED DESCRIPTION

The present invention relates to a drive over vehicle inspection system (“DOVIS”). One skilled in the art will appreciate that various aspects of the invention may be realized by any number of materials or methods configured to perform the intended functions. For example, other materials or methods may be incorporated herein to perform the intended functions. It should also be noted that the drawings herein are not all drawn to scale, but may be exaggerated to illustrate various aspects of the invention, and in that regard, the drawings should not be limiting.

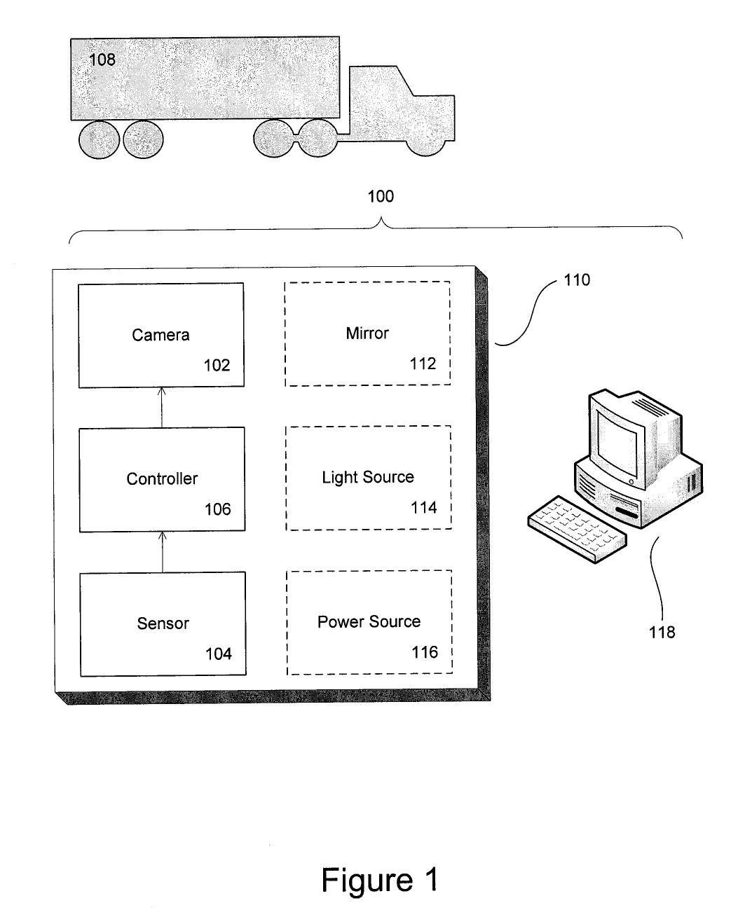

In accordance with exemplary embodiments, and with reference to FIG. 1, a DOVIS 100 comprises a camera 102, a sensor 104, and a controller 106. In accordance with exemplary embodiments, DOVIS 100 may also comprise one or more mirrors 112, light sources 114, and/or power sources 116. In accordance with additional exemplary embodiments, DOVIS 100 may also comprise image viewing/enhancing hardware and software 118. In various exemplary embodiments, sensor 104 may be coupled in communication with controller 106. Similarly, controller 106 may be coupled in communication with camera 102.

In general, any component of DOVIS 100 may be made of any suitable material, including, but not limited to, aluminum, fiberglass, plastic and the like. In some embodiments, one or more coatings, for example, a powder or non-skid coating, are applied to strengthen or protect a component of DOVIS 100. For example, powder coating may help prevent corrosion and/or withstand heat.

Moreover, any component of DOVIS 100 may be coupled to each other via bolts, screws, dowels, adhesives, glue, welding, soldering, brazing, sleeves, brackets, clips, magnetism, or other means known in the art or hereinafter developed. The coupling may be permanent or temporary, and the coupling may include an adjustable coupling, thereby allowing the components to be extended away from each other or closer to each other.

Camera

In accordance with exemplary embodiments, camera 102 is located within a housing 110. Camera 102 may be positioned for a vehicle 108 to be driven over it. In accordance with exemplary embodiments, camera 102 comprises one or more of a still area scan camera, video camera, and line scan camera. For example, in one exemplary embodiment, camera 102 is a line scan camera. In various exemplary embodiments, camera 102 is digital. In other exemplary embodiments, camera 102 is a high resolution camera. In exemplary embodiments, camera 102 comprises one or more specialty lenses (e.g., a wide angle lens, an ultra wide angle lens or a fish-eye lens). The specialty lenses may be configured, for example, to create a wider field of view for camera 102 or to enable camera 102 to view objects that might otherwise be hidden.

In exemplary embodiments, camera 102 comprises one or more adjustable settings including, but not limited to, exposure time, scan rate, zoom, and aperture. In general, camera 102 is any device configured to capture images of all or a portion of the undercarriage of vehicle 108.

Sensor

As vehicle 108 drives over camera 102, its speed may vary. Moreover, baseline speed will differ from one vehicle to the next. Therefore, in accordance with exemplary embodiments, sensor 104 comprises one or more of a speed sensor or other sensor. In exemplary embodiments, sensor 104 is a radar sensor (e.g., a Doppler sensor), a laser sensor, an image based sensor, or another sensor now known or later discovered. In exemplary embodiments, sensor 104 functions for vehicle 108 moving either forward or backward.

In accordance with exemplary embodiments, sensor 104 is located within housing 110, while in other embodiments, sensor 104 is a standalone device in communication with controller 106. For example, sensor 104 may be located in front of, behind, above, below, or lateral to vehicle 108, and in communication (e.g., wireless or otherwise) with controller 106. In general, sensor 104 is any device configured to detect instant and/or variable speed of vehicle 108 as it is driven over housing 110. In one exemplary embodiment, sensor 104 is configured to detect changes in the speed of vehicle 108 (i.e., relative speed). In another exemplary embodiment, sensor 104 is configured to detect the actual speed. In further exemplary embodiments, sensor 104 is configured to detect acceleration or deceleration. Moreover, sensor 104 may be configured to provide any signals that facilitate adjustment of one or more settings on a camera. Sensor 104 may be any sensor configured to provide signals that facilitate the taking a line scan photo of a vehicle while it travels at variable speed, wherein the photo is similar in quality to a photo taken of a vehicle traveling a constant speed.

Controller

In accordance with exemplary embodiments, controller 106 is programmed with one or more algorithms to adjust one or more settings of camera 102 in response to data collected by sensor 104.

In accordance with exemplary embodiments, controller 106 is a standalone device, while in other embodiments, controller 106 is integral with camera 102 or sensor 104. In general, controller 106 is in communication with camera 102 and sensor 104.

In accordance with exemplary embodiments, if the vehicle goes slower, as detected by sensor 104, the exposure time is increased or the scan rate is decreased by controller 106. Alternatively, if the vehicle goes faster, as detected by sensor 104, the exposure time is decreased' or the scan rate is increased by controller 106.

In exemplary embodiments, data communicated by controller 106 to camera 102 comprises clock pulse frequency for a line scan camera. In exemplary embodiments, clock pulse frequency is a function of vehicle speed.

In exemplary embodiments, sensor 104 outputs data having a linear relationship to vehicle speed. For example, sensor 104 may output from about 35 to about 55 Hz/mph. In exemplary embodiments, the relationship between clock pulse frequency and vehicle speed is linear or otherwise uncurved. However, one skilled in the art will appreciate that in other exemplary embodiments, the relationship between clock pulse frequency and vehicle speed is defined by a sigmoid, conic constant or other polynomial expression. Therefore, in exemplary embodiments, controller 106 processes data received from sensor 104 prior to communicating it to camera 102.

In accordance with exemplary embodiments, clock pulse frequency at 1 mph is from about 615 Hz to about 815 Hz; clock pulse frequency at 2 mph is from about 1 kHz to about 1.4 kHz; and clock pulse frequency at 10 mph is from about 4 kHz to about 8 kHz.

In exemplary embodiments, data communicated by controller 106 to camera 102 further comprises exposure duty cycle. In exemplary embodiments, camera 102 gathers light during the off cycle and processes images during the on cycle. In exemplary embodiments, exposure duty cycle varies from about 99% to about 1%. In exemplary embodiments, exposure duty cycle varies based on vehicle speed. In exemplary embodiments, adjusting exposure duty cycle improved exposure.

In general, controller 106 is any device configured to adjust the settings of camera 102 in response to data collected by sensor 104 to thereby compensate for variations in the speed of vehicle 108, and for example, maintain a constant aspect ratio of the image. Thus, controller 106, and more generally DOVIS 100, is configured to facilitate improved imaging of the underside of vehicles. One exemplary way of describing this improved imaging is that the size of the photo is independent of the speed of the vehicle. Another exemplary way of describing the quality of the imaging from DOVIS 100 is that the aspect ratio is constant throughout the photo. In this manner, images may be clearer than those obtained using prior art technology. This may facilitate better detection of contraband and the like hidden in the undercarriages of vehicles.

Mirror

In accordance with exemplary embodiments, DOVIS 100 further comprises one or more mirrors 112 (e.g., flat, planar, concave or convex) positioned relative to camera 102 so as to create a wider field of view for camera 102. In accordance with other exemplary embodiments, DOVIS 100 further comprises one or more tiltable mirrors 112 (e.g., tilted forward, backward or to the side) positioned relative to camera 102 to enable camera 102 to view objects that might otherwise be hidden. In accordance with exemplary embodiments, mirrors 112 are located within housing 110. In general, any material or substance that provides reflective properties adequate to create a wider field of view for camera 102 or to enable camera 102 to view objects that might otherwise be hidden is within the scope of this invention.

Light Source

In accordance with exemplary embodiments, DOVIS 100 further comprises one or more light sources 114. In accordance with exemplary embodiments, light source 114 is located within housing 110. In some embodiments light source 114 is a halogen light assembly, while it is an LED light assembly in other embodiments. In accordance with exemplary embodiments, one or more LED lights are mounted in a camera box (described below). In accordance with various aspects of exemplary embodiments, one or more LED lights reflect light through one or more mirrors 112.

In some embodiments, amplitude or intensity of light source 114 is adjusted by controller 106 in response to data collected by a sensor 104, for example, a vehicle height sensor, a light sensor, or another ambient condition sensor. In general, a light source 114 may be any device used to illuminate or otherwise provide optimal image capturing conditions for camera 102.

Power Source

In accordance with exemplary embodiments, DOVIS 100 further comprises one or more power sources 116. In accordance with exemplary embodiments, power source 116 is located within housing 110. Power source 116 may be an independent power source, such as a battery or a generator, or merely a connection to a power source, such as an electrical cord or outlet or existing power line. In general, a power source 116 may be any device used to directly or indirectly provide power to any component of DOVIS 100.

Image Viewing/Enhancing Hardware and Software

In accordance with exemplary embodiments, DOVIS 100 further comprises image viewing/enhancing hardware and software 118. In some embodiments, viewing/enhancing hardware and software 118 comprises a device or system configured to control DOVIS 100, such as an operator control unit (OCU). In other exemplary embodiments, the OCU may be a passive device configured to only display images provided to it. In an exemplary embodiment, a single OCU controls a single camera 102. In some embodiments, a single OCU controls more than one camera 102. In some embodiments, a single OCU controls the devices in more than one housing 110. In some embodiments, viewing/enhancing hardware and software 118 causes camera 102 to pan, tilt and/or zoom, one or more mirrors 112 to tilt, or the amplitude or intensity of light source 114 to change. In some embodiments, viewing/enhancing hardware and software 118 is configured to allow an inspector to view, manipulate, save, export, review and/or compare images captured by camera 102. In some embodiments, viewing/enhancing hardware and software 118 is configured for remote access. In general, image viewing/enhancing hardware and software 118 may be any device or system used to capture, view and assess images of all or a portion of the undercarriage of vehicle 108, captured by camera 102. In exemplary embodiments, images may be saved using compression software. For example, a JPEG compression software routine may be used. Other methods of saving and/or formatting images may also be used. The compression could be performed, for example, in the OCU, in the controller, or in any suitable portion of the system.

Housing

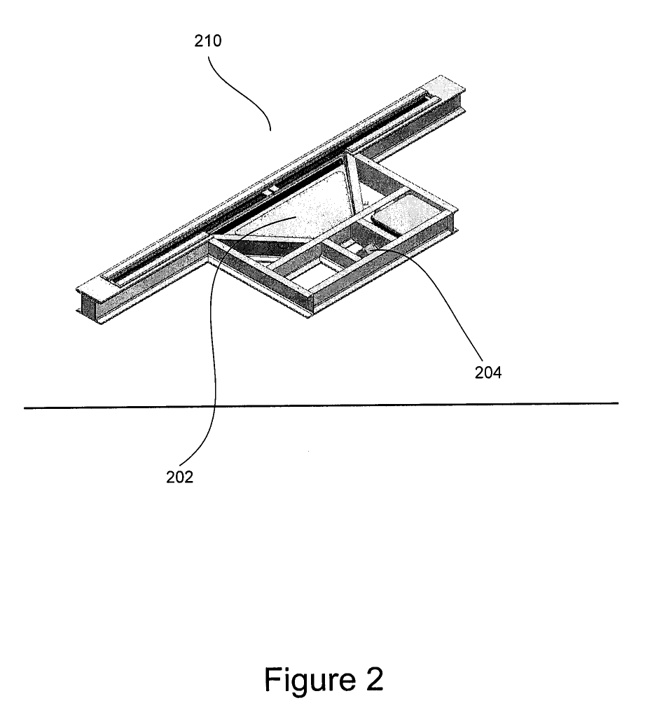

As referenced above, one or more components of DOVIS 100 may be contained all or partially within housing 110. In exemplary embodiments, and with reference to FIG. 2, a housing 210 comprises a camera 202 (hidden from view) and a sensor 204. The sensor 204 may be configured to be permanently installed in the ground, when consistent, long-term security is required. In such embodiments, housing 210 may be flush with the driving surface.

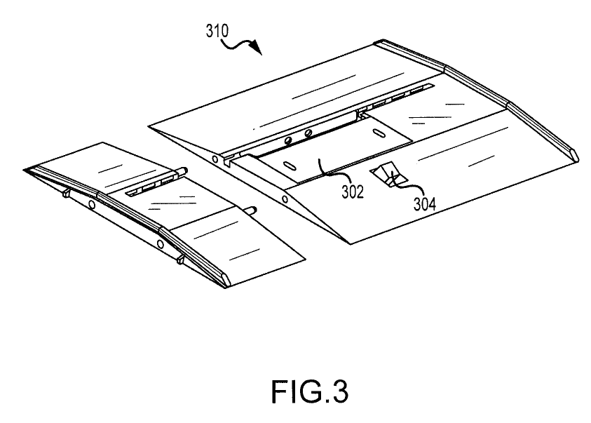

In other exemplary embodiments, and with reference to FIG. 3, a housing 310 comprises a camera 302 (hidden from view) and a sensor 304. In an exemplary embodiment, housing 310 is configured to be a portable device located above the ground, similar to a ramp or speed bump. For example, housing 310 may be just over 4 inches high in the center. Furthermore, housing 310 may be any suitable height. In some embodiments, housing 310 is a multiple piece housing to provide for easy storage or transport, for example, a two-piece, three-piece, or four-piece housing. Housing 310 may, in other embodiments be a single piece housing.

In yet other exemplary embodiments, a housing is configured for installation between train rails to capture an under-vehicle image of a train of arbitrary length.

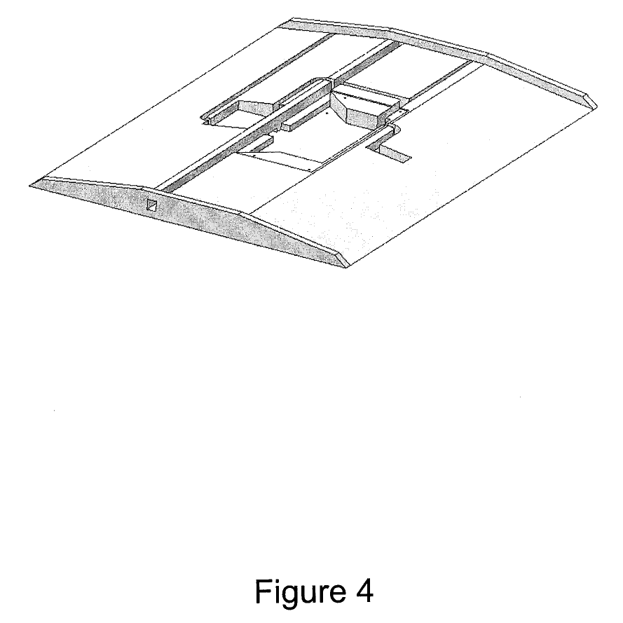

In exemplary embodiments, housing 110 may contain built-in locations for one or more of camera 102, sensor 104, controller 106, mirrors 112, light sources 114, or power sources 116. For example, and with reference to FIG. 4, the housing may be molded to form recesses, compartments, apertures, and/or the like. The molded housing may be configured to contain one or more components within the one or more recesses, compartments, apertures, and/or the like.

Moreover, various individual components of DOVIS 100 may be individually housed within housing 110, including within any locations built in to the housing.

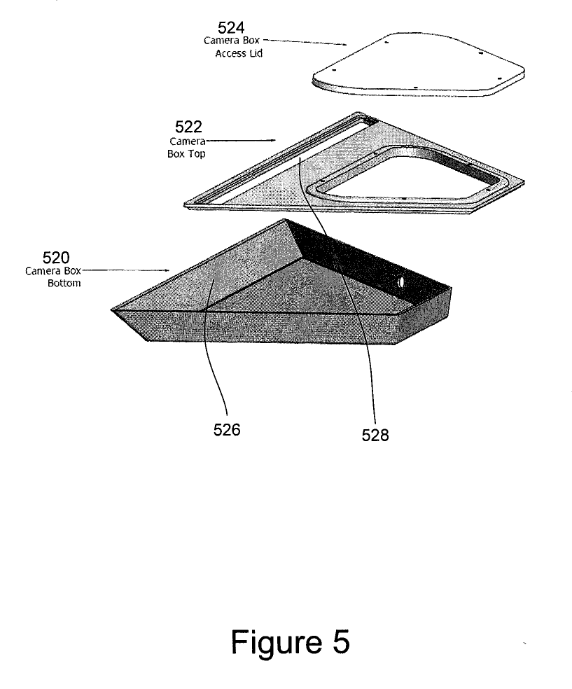

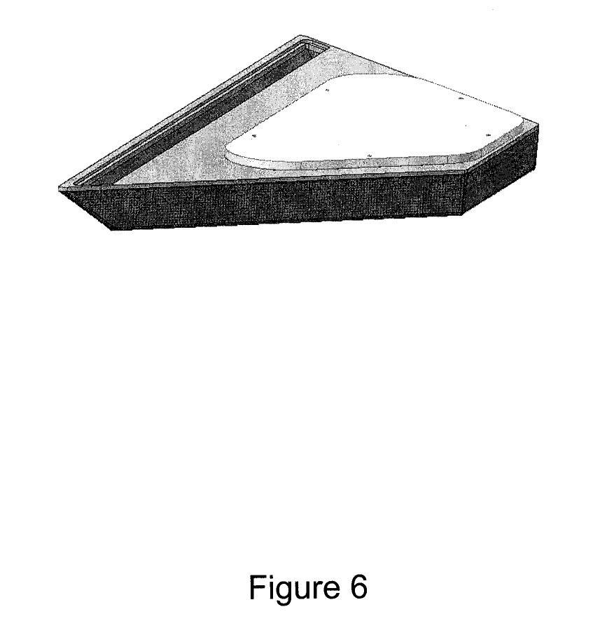

In an exemplary embodiment, camera 102 is enclosed in a separate housing. For example, and with reference to FIG. 5, an exemplary camera box comprises a camera box bottom 520, a camera box top 522, and a camera box access lid 524. (FIG. 6 merely illustrates the same camera box of FIG. 5, but in its assembled form.) Notably, camera box bottom 520 comprises an angled wall 526. In one exemplary embodiment, angled wall 526 is configured to support a mirror to create a wider field of view for camera 102. In another exemplary embodiment, angled wall 526 is configured to support a mirror to view objects that might otherwise be hidden. In an exemplary embodiment, camera box top 522 is glued permanently onto camera box bottom 520, and a glass window for camera 102's view is glued permanently into a window groove 528. In this exemplary embodiment, access to camera 102 is through camera box access lid 524. The underside of camera box access lid 524 features a pour-in-place gasket that seals the camera box water-tight and/or air-tight.

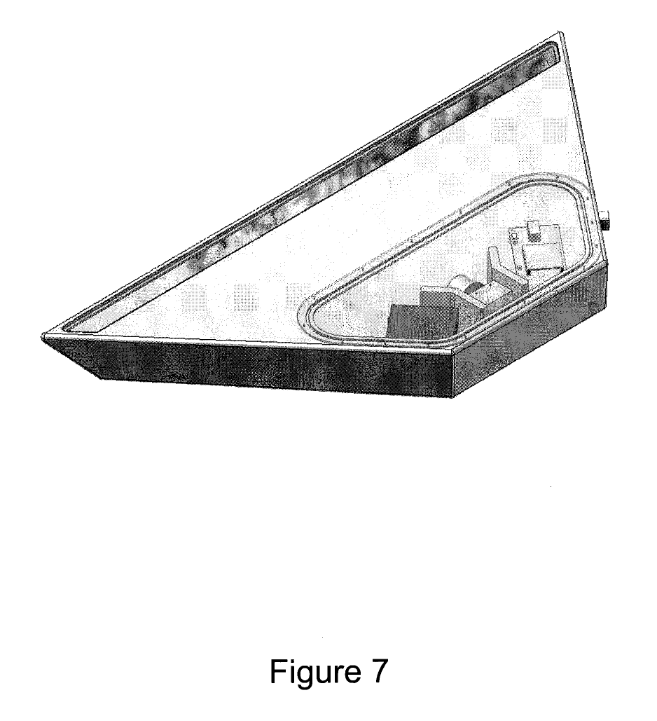

In an exemplary embodiment, and with reference to FIG. 7, a camera box may be rotationally molded (rotomolded) to provide cost savings and/or enable the addition of desirable design elements.

Additional Features

As will now be discussed, several additional features may be incorporated into DOVIS 100. For example, cooling, light box and/or camera box window cleaning, wheel well imaging, vehicle and/or driver identification, weigh-in-motion scales, and anomaly detection.

In some embodiments, it may be desirable to cool one or more temperature sensitive components of DOVIS 100. For example, one or more of camera 102, light sources 114, and power sources 116 may be susceptible to heating. Therefore, in exemplary embodiments, DOVIS 100 comprises a cooling system.

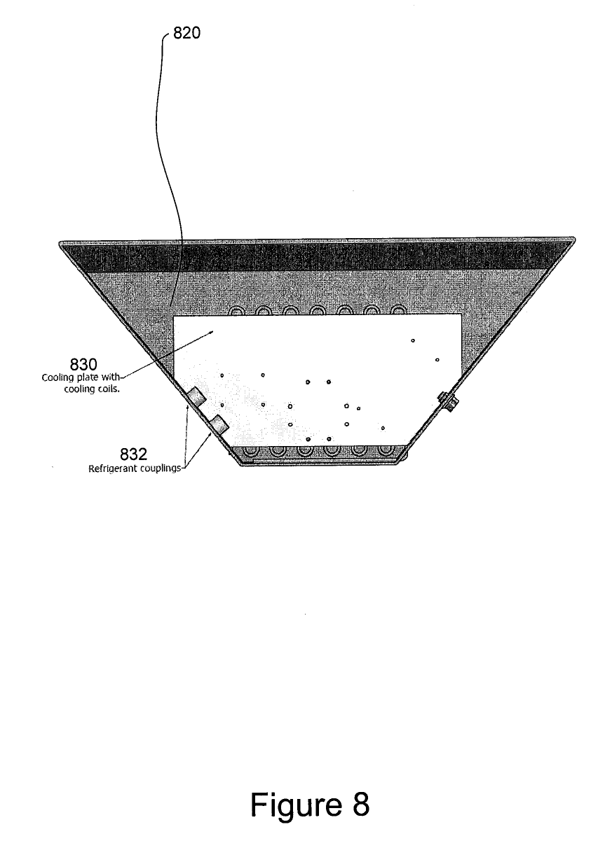

The cooling system may be active or passive. In exemplary embodiments, and with reference to FIG. 8, the cooling system comprises a refrigeration system having a cooling plate with one or more cooling coils 830 located within camera box bottom 820. In exemplary embodiments, the cooling system further comprises refrigerant couplings 832 (e.g., quick-disconnect couplings). In exemplary embodiments, refrigerant enters camera box bottom 820 through refrigerant couplings 832, flows through cooling plate with cooling coils 830, and then recirculates back to a refrigeration unit.

In exemplary embodiments, the cooling system comprises a passive element, in addition to or in place of, an active element. An exemplary passive element comprises using a thermally responsive phase change material. For example, as temperature increases to a specified temperature, a material may change phase to absorb heat. Conversely, as temperature decreases to a specified temperature, a material may change back to a solid. Phase change materials may be located throughout DOVIS 100, and in any suitable quantity.

In general, any system designed to maintain an optimal temperature for one or more temperature sensitive components is appropriate for use in connection with DOVIS 100.

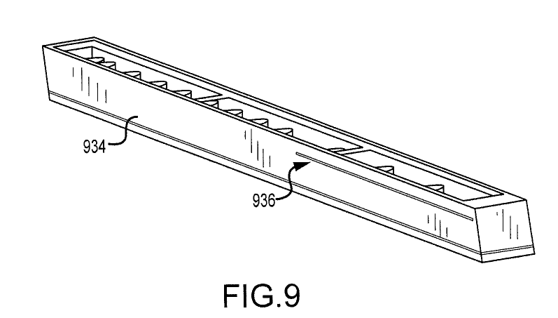

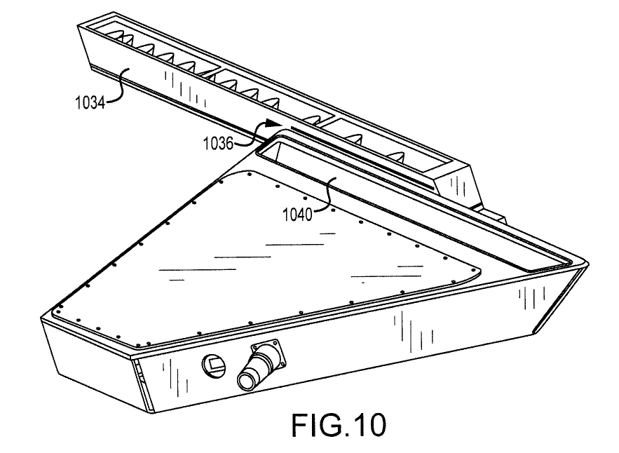

One skilled in the art will appreciate that image quality is affected by lighting. Therefore, and as noted herein, DOVIS 100 may comprise one or more light sources 114 located within housing 110. In that regard, and with reference to FIGS. 9 and 10, an exemplary DOVIS 100 may comprise one of exemplary light boxes 934 and 1034, respectively.

When substances such as dirt or mud come into contact with the light box window, lighting is affected. Moreover, image quality is affected when substances come into contact with the camera box window. Therefore, in accordance with exemplary embodiments, DOVIS 100 may further comprise a system or method for light box and/or camera box window cleaning.

In some embodiments, high velocity air is passed over a camera box window 1040, for example through an air slit 936 or 1036 in light box 934 or 1034.

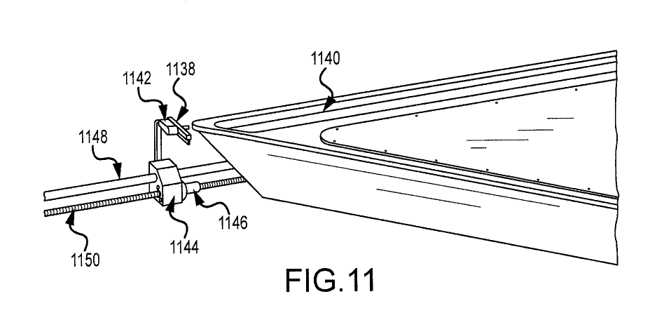

In other embodiments, and with reference to FIG. 11, a wiper 1138 is mechanically passed over a camera box window 1140. In accordance with an exemplary embodiment, wiper 1138 is attached to a wiper arm 1142; wiper arm 1142 is attached to a guide block 1144 coupled to a nut 1146; and guide block 1144 moves along a guide rail 1148 as a threaded rod 1150 is turned by a motor. In other embodiments, wiper 1138 moves by one or more linear actuators or by using air. Furthermore any method of moving wiper 1138 may be used, so long as it facilitates motion of the wiper and wiping of the camera box window.

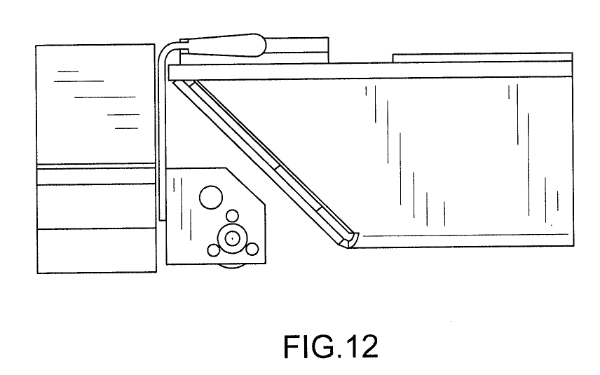

FIG. 12 merely illustrates an exemplary side view of the camera box window cleaning system of FIG. 11.

The above examples however, should not be construed as limiting. In general, any system designed to keep the light box and/or the camera box window free of dirt or mud, or any other light impeding substance, is appropriate for use in connection with DOVIS 100.

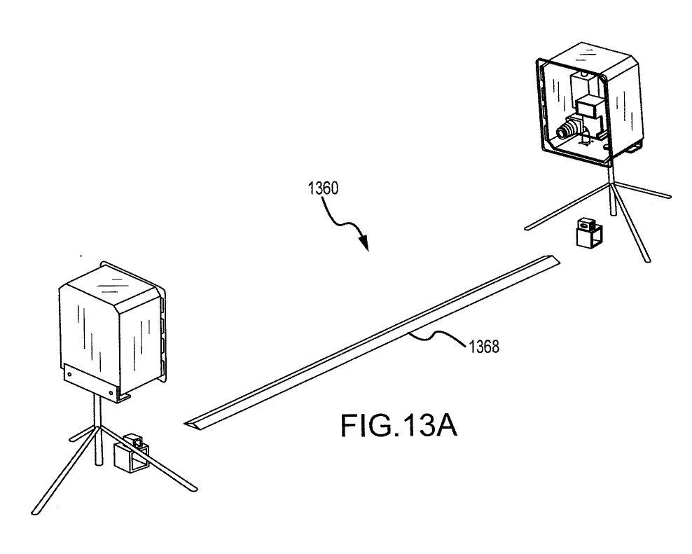

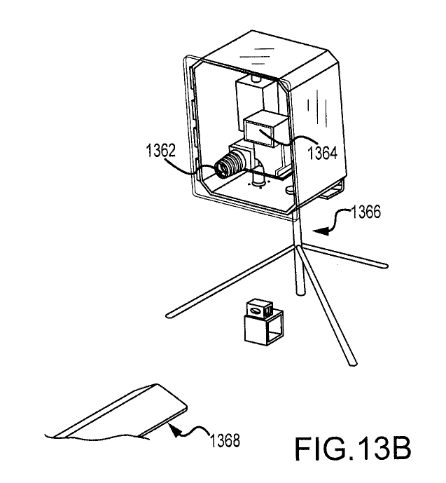

In some embodiments, DOVIS 100 further comprises wheel well imaging devices. With reference now to FIGS. 13A and 13B, in exemplary embodiments, a wheel well imaging system 1360 comprises a camera 1362 and optionally a flash 1364, optionally mounted on an adjustable tripod 1366. Camera 1362 and flash 1364 could be triggered manually or by a sensor (e.g., optical or mechanical sensor 1368). Furthermore, any suitable triggering device and/or method may be used. In addition to inspecting wheel wells, which are a common place for stowing contraband, camera 1362 could image a vehicle's make/model, license plate, VIN number, and/or occupants. Camera 1362 could be a still area scan camera or a video camera. Furthermore, camera 1362 may be any suitable device for producing visual image(s). In exemplary embodiments, camera 1362 can pan, tilt and/or zoom to allow the inspector to selectively focus in on suspicious areas of the vehicle.

In some embodiments, DOVIS 100 further comprises vehicle and/or driver identification. For example, DOVIS 100 may comprise RFID tag readers to scan tags associated with a particular driver or vehicle. In some embodiments, DOVIS 100 further comprises weigh-in-motion scales to determine if the actual vehicle weight is consistent with expected weight. In other embodiments, DOVIS 100 further comprises anomaly detection, for example, auto image analysis and contraband detection with minimal human involvement. In exemplary embodiments, DOVIS 100 may comprise one or more of radiation sensors, chemical sensors, and additional still area scan and/or video cameras. In exemplary embodiments, DOVIS 100 comprises a hub for connection of ancillary devices or systems.

Methods

In accordance with exemplary methods of use, as the vehicle is driven over the camera, the controller sends signals, based on information from the speed sensor, to the camera to adjust the camera setting(s). In exemplary embodiments, the controller performs this routine either continuously or at predetermined intervals. The result is that vehicle speed is not reflected in the image.

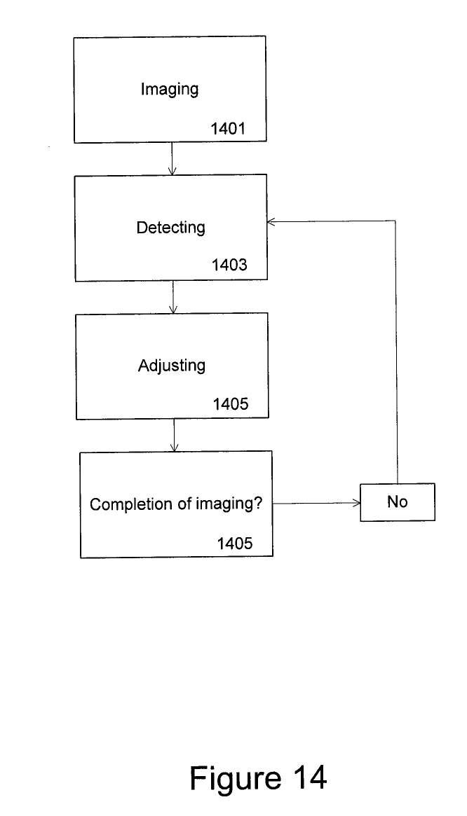

With reference now to FIG. 14, an exemplary method for imaging the undercarriage of a vehicle comprises the steps of: imaging the undercarriage of a vehicle (or portions thereof) using a line scan camera (step 1401); detecting the speed of the vehicle (step 1403); and adjusting one or more settings of the line scan camera based on information about the speed of the vehicle (step 1405). Imaging (step 1401) continues, and steps 1403 and 1405 repeat, until completion of imaging (step 1407). In exemplary embodiments, the imaging is controlled based on data related to the absolute or relative vehicle speed, and changes therein, as sensed by the speed sensor. It is noted that detecting the speed of the vehicle (step 1403) may comprise detecting a change in the speed of the vehicle, detecting relative speed of the vehicle, detecting the speed of the vehicle, detecting acceleration of the vehicle, and/or the like. Similarly, the adjusting (step 1405) may comprise adjusting one or more settings of the line scan camera to compensate for changes in vehicle speed. Adjusting settings of the line scan camera, however, may be based on any speed related data such as the types of speed related data just described.

One skilled in the art will appreciate that numerous variations on the foregoing methods, consistent with the DOVISes described herein, are all within the spirit and scope of the present invention. For example, either of the foregoing exemplary embodiments may comprise the additional step of providing a resultant image to a user for analysis.

The foregoing disclosure is illustrative of the present invention and is not to be construed as limiting the invention. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention, and are not to be construed as limited to the specific embodiments disclosed.

What is claimed is:

1. A drive over vehicle undercarriage inspection system, comprising:
a vehicle undercarriage inspection housing comprising:
a camera configured to image at least a portion of a vehicle's undercarriage,
a sensor configured to detect a speed of said vehicle, and
a controller configured to adjust one or more settings of said line scan camera in response to said speed.

2. The drive over vehicle undercarriage inspection system of claim 1, wherein the vehicle undercarriage inspection housing is implemented in a plurality of separately transportable and mechanically assembled pieces.

3. The drive over vehicle undercarriage inspection system of claim 2, wherein each one of the plurality of pieces is, at least in part, formed from aluminum.

4. The drive over vehicle undercarriage inspection system of claim 3, wherein the aluminum is powder coated to provide corrosion resistance.

5. The drive over vehicle undercarriage inspection system of claim 1, wherein the vehicle undercarriage inspection housing is formed from molded fiberglass.

6. The drive over vehicle undercarriage inspection system of claim 5, wherein the vehicle undercarriage inspection housing is implemented in a plurality of separately transportable and mechanically assembled pieces.

7. The drive over vehicle undercarriage inspection system of claim 5, wherein the vehicle undercarriage inspection housing comprises a recess configured to receive a camera box incorporating the line scan camera.

8. The drive over vehicle undercarriage inspection system of claim 7, wherein the camera box comprises:
a molded fiberglass bottom portion holding the line scan camera;
a box top covering the line scan camera; and
a camera access lid seated on the box top.

9. The drive over vehicle undercarriage inspection system of claim 7, wherein the camera box has associated therewith a cooling system.

10. The drive over vehicle undercarriage inspection system of claim 9, wherein the cooling system comprises at least one of a refrigeration system, a cooling plate and a cooling coil.

11. The drive over vehicle undercarriage inspection system of claim 9, wherein the cooling system comprises a thermally responsive phase change material.

12. The drive over vehicle undercarriage inspection system of claim 7, wherein the camera box comprises an air blowing mechanism operating to pass air over a camera box window through which the line scan camera images the vehicle undercarriage.

13. The drive over vehicle undercarriage inspection system of claim 7, wherein the camera box comprises a mechanical wiper passing over a camera box window through which the line scan camera images the vehicle undercarriage.

14. The drive over vehicle undercarriage inspection system of claim 1, further comprising a separately configurable wheel well imaging camera.

15. A drive over vehicle undercarriage inspection system, comprising:
a line scan camera configured to image at least a portion of a vehicle's undercarriage,
a sensor configured to detect a speed of said vehicle,
a controller configured to adjust one or more settings of said line scan camera in response to said speed;
a light source;
a sensor configured to detect a height of said vehicle, and
a controller configured to adjust the amplitude or intensity of said light source in response to said height.

16. A method for imaging the undercarriage of a vehicle, comprising the steps of:
imaging the undercarriage of a vehicle using a line scan camera;
detecting a change in the speed of said vehicle; and
adjusting one or more settings of said line scan camera to compensate for said change.
